(19) United States
(12) Patent Application Publication
(10) Pub. No.: US 2026/0289105 A1
(43) Pub. Date: Sep. 24, 2026

(54) SYSTEMS AND METHODS FOR AN ARTIFICIAL INTELLIGENCE EVALUATOR OF GENERATIVE MODELS

(71) Applicant: Salesforce, Inc., San Francisco, CA (US)

(72) Inventors: Yilun Zhou, New York, NY (US); Austin Xu, San Francisco, CA (US); Peifeng Wang, Sunnyvale, CA (US); Shafiq Rayhan Joty, San Jose, CA (US)

(21) Appl. No.: 19/085,324

(22) Filed: Mar. 20, 2025

(51) Int. Cl. G06F 40/20

(52) U.S. Cl. CPC G06F 40/20

(57) ABSTRACT

Embodiments described herein provide an evaluation framework for LLM-judges to evaluate the test-time scaling abilities of one or more LLM generators. Specifically, a variety of tasks may be employed for the LLM generators to generate a response, e.g., (i) response reranking, where the LLM-judge picks the best response out of several ones; (li) step-level beam search, where the LLM judge guides the LLM generator(s) to generate the response step-by-step, and (iii) critique-based refinement, where the LLM judge generates natural language critique to the response for the LLM generator to refine. Thus, through each or any combination of (i), (ii) and (iii), the LLM judge may iteratively improve a response generated by the LLM generator.

### TECHNICAL FIELD

The embodiments relate generally to machine learning systems for natural language processing, and more specifically to systems and methods for an artificial intelligence (AI) evaluator of generative models.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model such as a large language model (LLM) to generate an output such as in the form of a text response, or a series actions to complete a complex task, such as to network issue troubleshooting, etc. Such a generative language model receives a natural language input in the form of a sequence of tokens, and in turn generates a predicted distribution over a token space conditioned on the input sequence. Generated output tokens over time may in turn form the text response, or actions for completing the task.

With the increasing scaling of an LLM (e.g., model and training data sizes), to use an LLM to generate an output in response to a comprehensive input request is often computationally costly. Some AI agents may adopt external non-generative evaluators, such as a reward model, to scale test-time computation, or afford a generator LLM extra compute during inference. For example, the evaluator model, which gives a quality signal to various generated responses, may be used to select the LLM with the trade-off between generative accuracy and computational cost, helping to decide when or whether to allocate more resources during inference. However, it remains challenging to evaluate how accurate or helpful the evaluation performed by these reward models are in deciding on the LLM generation at inference.

### BRIEF DESCRIPTION OF THE DRAWINGS

FIG. 1 shows an example user interface (UI) of an AI agent for a user to enter a user query or task request, according to embodiments described herein.

FIG. 2 is a simplified diagram illustrating a test-time scaling framework for LLM generators to operate with one or more LLM judges to generate and update a response, according to embodiments described herein.

FIGS. 3A-3C provide alternative LLM judge guided generative frameworks, which may be jointly evaluate the LLM judge, according to embodiments.

FIG. 4 is a simplified diagram illustrating a computing device implementing the AI agent described in FIGS. 1-3, according to some embodiments.

FIG. 5 is a simplified diagram illustrating a neural network structure, according to some embodiments.

FIG. 6 is a simplified block diagram of a networked system suitable for implementing the AI agent described in FIGS. 1-5 and other embodiments described herein.

FIG. 7 is an example logic flow diagram illustrating a method of test-time resource scaling for neural network based language models based on the framework shown in FIGS. 1-6, according to some embodiments described herein.

FIGS. 8-19 provide example results of data experiments of LLM judge evaluation framework for test-time scaling described in FIGS. 1-7, according to embodiments described in.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

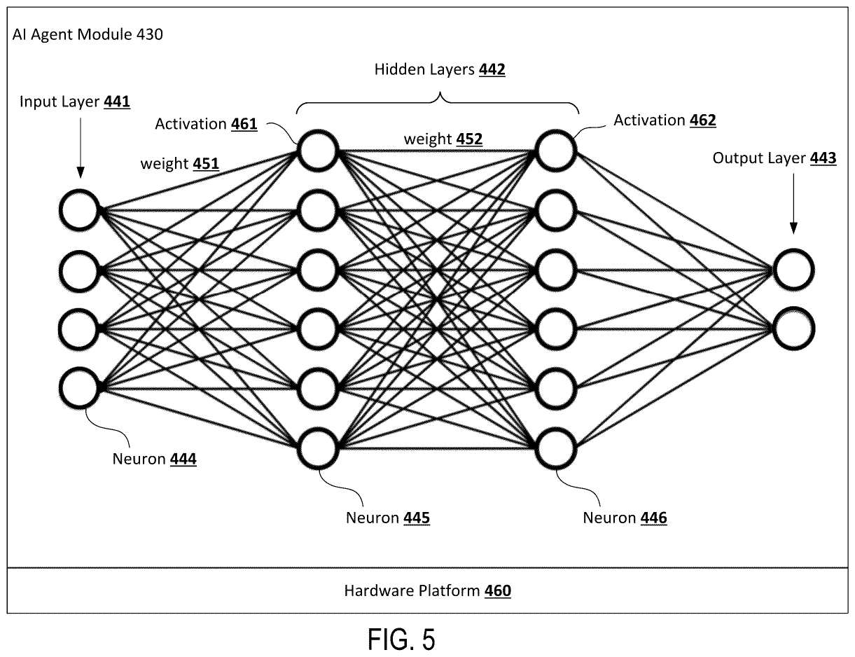

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant number of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

With increased size and thus training cost of LLMs, test-time scaling may be an alternative solution to model training, in which more compute is dedicated at the test time in the hope that better model responses are generated. For example, at test time (inference), an evaluator model may give a quality signal to various generated responses from various candidate LLMs to decide on whether the candidate LLMs are sufficiently trained to generate accurate answers under a selected metric. The evaluator model may be a separate LLM, referred to as “LLM judges,” which are often smaller in size (with fewer layers, neurons and/or weights) than a LLM generator, and instructed by one or more system prompts to give different types of judgment like binary yes/no answers, numerical scores, fine-grained feedback, etc., to candidate responses generated by LLM generators. Based on such evaluation, an LLM generator may be selected, e.g., to handle a particular type of user requests, of a particular domain, and/or the like. However, it remains challenging to evaluate how accurate or helpful the evaluation performed by these reward models are in deciding on the LLM generation at inference.

Embodiments described herein provide an evaluation framework for LLM-judges to evaluate the test-time scaling abilities of one or more LLM generators. Specifically, a variety of tasks may be employed for the LLM generators to generate a response, e.g., (i) response reranking, where the LLM-judge picks the best response out of several ones; (li) step-level beam search, where the LLM judge guides the LLM generator(s) to generate the response step-by-step, and (iii) critique-based refinement, where the LLM judge generates natural language critique to the response for the LLM generator to refine. Thus, through each or any combination of (i), (ii) and (iii), the LLM judge may iteratively improve a response generated by the LLM generator. The effects of LLM judge guided test-time scaling may then be assessed based on the quality of the final responses. In this way, the most beneficial LLM judge for a particular LLM generator may be selected to boost test-time scaling of the LLM generator.

For example, a number of different judge models, ranging in size from 7B to 70B parameters may be evaluated on the three test-time scaling tasks (i)-(iii). For each of the three tasks, queries from 3 different domains (math reasoning, code generation, and instruction following) may be used for multiple LLM generator to generate responses, ranging in size from 6.7B to 72B parameters. For instance, weak LLM judges (e.g., 8B) can help strong LLM generators (e.g., 72B) in easier tasks, such as instruction following, but not in reasoning-intensive tasks like coding or math. Larger LLMjudges bring the most benefit for math and instruction following tasks, but no evaluated LLM judges are able to reliably improve generator performance for coding. Lastly, while natural language critiques are touted as a defining advantage of judges over reward models, such critiques have significant room for improvement in terms of utility.

In this way, the evaluation framework provides evaluation metrics for an LLM generator to match with a LLM judge for guided generation according to a particular domain or task type. With iterative generation guided by the LLM judge, the LLM generator may dynamically determine if more computation is needed based on output assessment, so as to optimize its inference process, balancing cost, speed and accuracy in real time. With improved hardware efficiency of generative inference, computer technology in LLMs is improved.

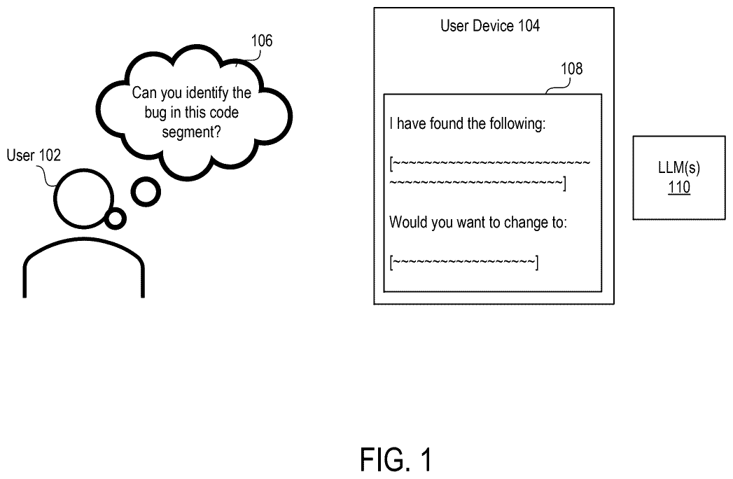

FIG. 1 shows an example user interface (UI) of an AI agent for a user to enter a user query or task request, according to embodiments described herein. A user 102 may utter a query 106 in natural language. For example, the query 106 may relate to a task request for a real-world application, such as to “identify the bug” in a code segment. In response, a user device 104 may output/display an answer 108 on a display interface, such as a screen. In some embodiments, answer 108 is the output of an artificial intelligence (AI) agent, which is built on a server that is communicatively connected to user device 104. The AI agent may be based on, or include, an LLM 110. In some embodiments, the LLM 110 receives query 106 through an application programming interface (API), which may append a system prompt to instruct the LLM 110 how to generate a response 108 to the query 106.

In some embodiments, LLM 110 may comprise a multi-modal LLM to receive an input of both text and image, e.g., a geometry image and a math problem for math reasoning task.

As another example, query 106 may include a question of “identify the bug” in a code segment. The AI agent may include the query 106 in a predefined format providing instruction to the LLM 110 how to generate a response to query 106, referred to as a “prompt,” which may be fed to an LLM as input. The LLM 110 may in turn provide answer 108, e.g., the identified bug, and/or a suggested correction.

The underlying LLM may be implemented at user device 104, or at a remote server which is accessible by the user device 104. The LLM may be trained with a large corpus of texts, code segments and/or documents to provide a response.

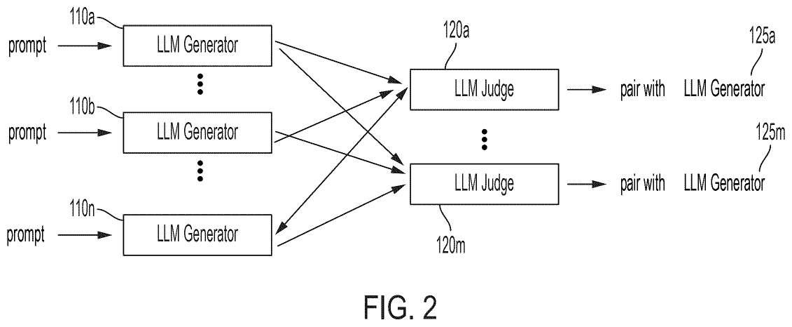

As a result, with increased size and thus training cost of LLMs (e.g., larger dataset and longer code or text samples), a balance between training cost (time and hardware expense) and inference performance of LLM 110 may often be considered. For example, some AI systems may restrict the training cost but scale the LLM 110 at inference (test) time for the LLM 110 to iteratively improve and/or update a generated response. In that case, an LLM 110 may pair with a particular (another) LLM as an evaluator as shown in FIG. 2.

FIG. 2 is a simplified diagram illustrating a test-time scaling framework for LLM generators to operate with one or more LLM judges to generate and update a response, according to embodiments described herein.

In one embodiment, given different LLM generators 110a-n, e.g., of different sizes, architectures, and/or pretraining recipes, a task request prompt may be fed to the respective LLM generator 110a-n. The generation process may be guided by one or more LLM judges 120a-m for test-tie scaling. For example, Test-time scaling of LLM generators 120a-n can be optimized by leveraging an LLM judges 120a-m to guide the generation process, dynamically allocating computational resources based on quality assessment. For example, instead of executing a fixed number of decoding steps or uniformly applying heavy computation across all tokens, a LLM judge 120a-m may assess partial outputs in real time, determining whether additional refinement is necessary. This approach enables strategies like early stopping when a response meets quality thresholds or iterative refinement where only low-confidence segments are reprocessed with deeper computation. Additionally, evaluator-guided speculative decoding allows for efficient verification of draft outputs proposed by a smaller model, reducing redundant computation while maintaining response accuracy. By incorporating LLM judges, test-time scaling becomes more adaptive, ensuring high-quality generations with optimized efficiency.

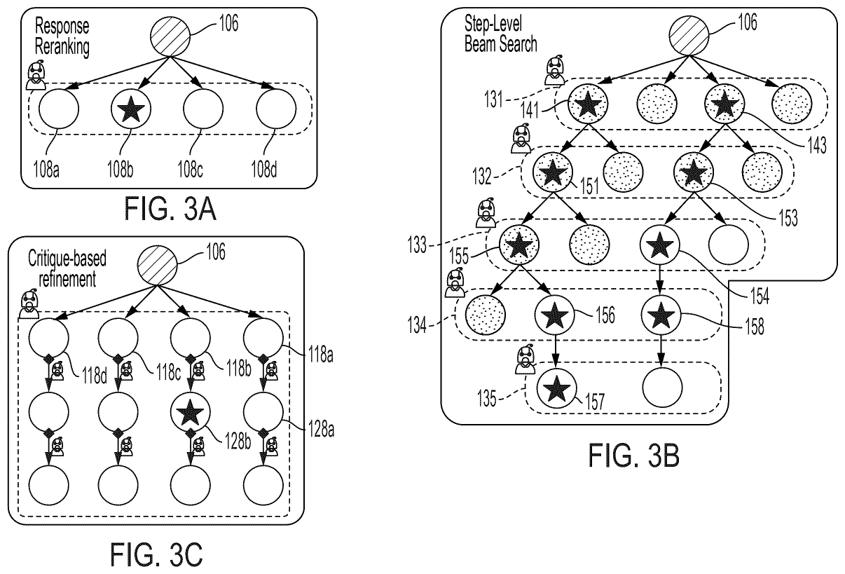

Using the different iterative approaches shown in FIGS. 3A-3C, the effect, e.g., the extent LLM judge 120a-m may improve the response generation of LLM generators 110a-110n, may be quantified as a metric of helpfulness. In this way, the LLM generator may be paired with LLM judge as pairs 125a, 125m to deployed for an AI agent.

FIGS. 3A-3C provide alternative LLM judge guided generative frameworks, which may be jointly evaluate the LLM judge, according to embodiments. For example, input query 106 may relate to various types of tasks, such as a request of math reasoning, code generation or instruction following, and/or the like.

As shown in FIG. 3A, a response re-ranking scheme may be implemented for an LLM generator (e.g., one of 110a-n in FIG. 2) to generate a response to input query 106. For example, the LLM generator model may generate and then sample multiple responses 108a-108d with stochastic decoding and the LLM judge (e.g., one of 120a-120m in FIG. 2) re-ranks the responses 108a-108d to select the best one 108b.

In one implementation, for example, greedy decoding may produce higher quality responses. Thus, or each input query 106, the LLM generator may generate a greedy response and multiple sampled responses 108a-d, e.g., with a temperature of 1.0 and top-p with p=0.95, for a total of 10 responses.

In one implementation, the LLM-judge may rerank and select the top response 18b for evaluation. When the LLM judge may not support one-shot direct reranking of multiple responses due to the total length of the responses 108a-d, pairwise round-robin and single-instance rating may be adopted. In the former, for the N responses, the N (N 1)/2 response pairs may be constructed such that the LLM judge may generate an output comparing an input of concatenated responses in each pair, assign the winner a score of 1 and the loser a score of 0, and select the response with the highest score (random tie-breaking if necessary). The selected “winner” responses are then formed into a group of pairs of response. The LLM judge may then iteratively evaluate the “winner” response from each pair to eventually select the best response 108b.

For example, an example prompt for LLM judge to perform pair wise comparison may take a form as:
You are a helpful assistant in evaluating the quality of the responses for a given instruction. Your goal is to select the best response for the given instruction.
Select Response A or Response B, that is better for the given instruction. The two responses are generated by two different AI chatbots respectively.
Do NOT say both/neither are good.

Here are some rules of the evaluation:
(1) You should prioritize evaluating whether the output honestly/precisely/closely executes the instruction, then consider its helpfulness, accuracy, level of detail, harmlessness, etc.
(2) Responses should NOT contain more/less than what the instruction asks for, as such responses do NOT precisely execute the instruction.
(3) You should avoid any potential bias and your judgment should be as objective as possible. Here are some potential sources of bias:
   The order in which the responses were presented should NOT affect your judgment, as Response A and Response B are
**equally likely** to be the better.
   The length of the responses should NOT affect your judgement, as a longer response does not necessarily correspond to a better response. When making your decision, evaluate if the response length is appropriate for the given instruction.
{partial_response_note}
Your reply should strictly follow this format:

```
  **Reasoning:** <feedback evaluating the responses>
  **Result:** <A or
  B> Here is the data.
  Instructon: “‘
{query_text} “‘
  Response A: “‘
{response_A} “‘
  Response B: “‘
{response_B} “‘
```

In the latter, the LLM judge may be instructed to generate a score (an integer between 1 and 5) for each candidate response 108a-d, and the select the response with the highest score. Since ties are much more common in this setting, all tied responses are tracked and report min, average and max performance; e.g., if for a test sample, a judge rates 3 of 10 responses as the highest score, and those 3 responses have accuracy labels (1, 0, 1), then the accuracy values (0, 2/3, 1) for this sample when aggregating (min, average, max) performance.

In one embodiment, a helpfulness metric of the LLM judge may be computed as

$$h = ( {p}_{j} - {p}_{g} ) / ( {p}_{o} - {p}_{g} ) , \qquad ( 1 )$$

where p_{g} is the average performance of the greedily decoded responses across the dataset, pₒ is the oracle judge performance over all response selections (e.g., selecting the correct response for a math problem whenever there is one), and pⱼ is the average performance of top responses reranked by the LLM judge. A negative value indicates strict harm as h=0 can be trivially achieved by just using the greedy response. Random baseline (i.e., the expected helpfulness of a judge that randomly reranks the responses) may be included to measure the quality of each judge to this “average” reranker. In addition, for GSM8k and MATH datasets, the performance scores of the majority-vote answer for each problem can be computed.

As shown in FIG. 3B, a step-level beam search scheme may be implemented for an LLM generator (e.g., one of 110a-n in FIG. 2) to generate a response to input query 106. Specifically, given an input query 106, a LLM judge is used as an evaluator to control the flow of generation through generation stages 131-135. For example, when the input query 106 comprises generating the response line-by-line to a coding problem, an LLM generator (e.g., any of 110a-n in FIG. 2) may, at a first stage 131, generate partial responses (e.g., a first few lines of code) and the LLM judge may decide that a newly generated line is bad and hence asks the LLM generator to resample a new line. In this task, beam search may be performed to generate an updated new line.

Therefore, a series of steps 131-134 may be performed to generate a response, usually in math and code tasks. For example, at each step 131-134, a new line (e.g., 141, 143, 151, 153, 155, 154, 156, 157, 158) of the response may be generated. The generated new line of code may represent a programmatic operation in the response to the input query 106.

In one embodiment, in a (N, M)-beam search with beam width of M, the LLM generator samples N first steps, which are reranked by the LLM judge to keep the top-N/M. Then, for each chosen step, the LLM generator samples M next steps, for a total of N responses to rerank again. For example, at step 131, the LLM generator generates 4 partial responses 141 and 143, and the LLM judge selects 141 and 143. For each selected partial responses 141 and 143, the LLM generator resamples 2 following partial responses at step 132, and the LLM judge reselects partial response 151 and 153. The resampling may continue at step 133 such that another 4 partial response or response are resampled, and reranked by the LLM judge. At step 133, full response 154 may be generated when the generation reaches an EOS token or the length limit. The LLM judge may rerank and select the top 2-partial response 155 and full response 154.

For example, an example prompt for LLM judge to evaluate partial responses may take a form similar to the following:
You are tasked with evaluating a response based on a given instruction (which may contain an Input). Provide a comprehensive feedback on the response quality based on the rules for evaluation. Follow this with a score between 1 and 5. Avoid generating any additional opening, closing, or explanations.

Here are some rules of the evaluation:
(1) You should prioritize evaluating whether the output honestly/precisely/closely executes the instruction, then consider its helpfulness, accuracy, level of detail, harmlessness, etc.
(2) Responses should NOT contain more/less than what the instruction asks for, as such responses do NOT precisely execute the instruction.
(3) You should avoid any potential bias and your judgment should be as objective as possible. Here is a potential source of bias:
   The length of the response should NOT affect your judgement, as a longer response does not necessarily correspond to a better response. When making your decision, evaluate if the response length is appropriate for the given instruction.
{partial_response_note}
Your reply should strictly follow this format:

```
  **Reasoning:** <Your feedback>
  **Result:** <an integer between 1
  and 5> Here is the data:
Instruction: “‘
{query_text} “‘
Respose: “‘
{response} “‘
```

At step 134, when a generation ends (due to the EOS token or length limit), the current step 133 is not expanded, resulting in less than N=4 responses, at which the LLM judge continues to select the top 2 responses 156 and 158. This process repeats until all selected steps are finished, e.g., at step 135, at which time a final reranking selects the top response 157. Similar to reason reranking, in each sampling, one response is greedily decoded and the rest are sampled with temperature of 1.0 and top-p of 0.95. In one example, (10, 2)-beam search may be used and limit the tree depth to 10.

In one embodiment, in the beam search, the LLM-judge generates reasoning for partial responses, which may be used to generate the reranking of the partial responses. An example system prompt for the LLM judge to generate reasoning may include “the model response is generated with streaming, meaning that it may not be finished yet but we still want to get a sense of the partial progress so far. If this is the case, you should provide judgment and feedback on the currently generated part, focusing on its correctness and promise of leading to a correct final solution.”

In one embodiment, a lookahead variant of beam search, where instead of sending partial responses to the LLM judge, partial responses are completed with greedy decoding to finish and send these “lookahead” versions (without adding the instruction above) to the LLM judge for reranking. To contextualize judge performances, the greedy, random and oracle performances are computed and derive normalized helpfulness metric as shown in Eq. (1).

As shown in FIG. 3C, a critique-based refinement scheme may be implemented for an LLM generator (e.g., one of 110a-n in FIG. 2) to generate a response to input query 106. The LLM judge may be used to generate natural language critiques, or explanations, for their judgments. The critique-based refinement task evaluates whether these critiques are helpful for the LLM generator to improve their response. Specifically, given input query 106, in a (N, M)-refinement setup, the LLM generator may generate N seed responses 118a-d, and each response is iteratively refined M times, for a total of N (M+1) responses (e.g., including the seed responses 118a-d, and revised responses 128a-b, etc.). The N (M+1) responses are reranked by the LLM judge at the end to select the top response 128b. Compared to reranking and beam search shown in FIG. 3B, in which the LLM judge reweighs the output distribution to resample, in refinement the LLM judge directly modifies the response with its critique.

As most LLM judges are finetuned on fixed judging templates, the LLM generator model may be used instead to revise the response itself given the LLM judge generated rating and critique. An example prompt for the LLM generator to revise the response is as follows:
You help revise a machine-generated response to a user query. Below, you will be provided with the user query and the
machine-generated response. You will also be provided with the output of an evaluator model, which gives a score (max
being {max_score}) and an explanation for the score.
You should revise and improve the current response, following the evaluator's recommendation. If the evaluator
does not identify any area of improvement, you should output “No revision needed.” Otherwise, you should output
the revised response surrounded by the <revised_response> and </revised_response> tags. You do not need to output

```
  anything else.
  <query>
  {query}
  </query>
  <original_response>
  {response}
  </original_response>
  <score>
  {score} out of {max_score}.
  </score>
  <explanation>
  {explanation}
  </explanation>
Your revision (or “No revision needed.”):
```

For example, a (1, 9)-refinement, which yields 10 responses in total to make it directly comparable to the reranking task may be adopted. For LLM judge helpfulness, instead of using the normalized helpfulness in Eq. (1), a new metric, relative improvement over reranking (§ judge), which is more suitable for this task:

$${δ}_{judge} = {p}_{judge}^{( Ref )} / {p}_{judge}^{( RR )} . \qquad ( 2 )$$

where, for (N, M)-refinement, p^{(Ref)}_{judge} is the average performance of the refined-and-reranked response across the dataset, and p^{(RR)}_{judge} is the average performance of the reranked response among N (M+1) randomly sampled ones (including the greedy), similar to response reranking.

### Computer and Network Environment

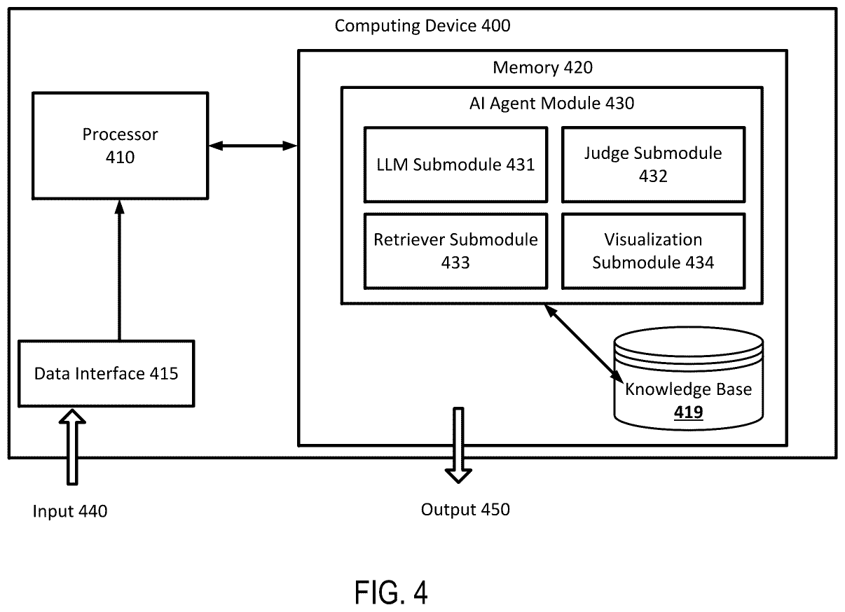

FIG. 4 is a simplified diagram illustrating a computing device implementing the AI assistant described in FIGS. 1-3, according to some embodiments. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on the same board, in the same package (e.g., system-in-package), on the same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 5.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI agent module 430 that may be used to implement and/or emulate the systems and models, and/or to implement any of the methods described further herein. AI agent module 430 may receive input 440 such as an input training data (e.g., documents or code snippets from fiction, papers, arxiv, wikipedia, codebases, and/or the like) via the data interface 415 and generate an output 450 which may be a response to the input, such as an answer to a question, an action manual, a programming code segment, and/or the like.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a query 203, from a user via the user interface.

In some embodiments, the AI agent module 430 is configured to generate a response to a user query in a wide variety of applications. The AI agent module 430 may further include LLM submodule 431 (e.g., similar to LLM generator 110a-n or LLM judge 120a-m in FIG. 2), a retriever module 432 (e.g., to retrieve relevant documents from knowledge base 419), a summarization submodule 433 (e.g., to summarize a document or text, etc.), and a visualization submodule 434 (e.g. to present a generated response via an UI). In one embodiment, the memory 420 may further store a knowledge base 419, e.g., storing a collection of documents 202.

Some examples of computing devices, such as computing device 400 may include non-transitory, tangible, machine readable media that include executable code that when run by one or more processors (e.g., processor 410) may cause the one or more processors to perform the processes of the method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the AI agent module 430 described in FIG. 4, according to some embodiments. In some embodiments, the AI agent module 430 and/or one or more of its submodules 431-434 may be implemented at least partially via an artificial neural network structure shown in FIG. 5. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a user query, a selected relevant document, a chunk, and/or the like. The number of nodes (neurons) in the input layer 441 may be determined by the dimensionality of the input data (e.g., the length of a vector of an input prompt combining a context and a user query). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the AI agent module 430 receives an input 440 of a query and transforms the input into an output 450 of a response. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include, but are not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 430 and/or one or more of its submodules 431-434 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer based LLM, and/or the like.

In one embodiment, the AI agent module 430 and its submodules 431-434 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, into encoded representations representing a high-dimensional embedding of the tokens. Such encoded representations capture various linguistic features and relationships among the tokens. The self-attention and feed-forward operations are iteratively performed through multiple layers of self-attention and feedforward layers, thereby generating an output based on the context of the input tokens. One forward pass for an input token to be processed through the multiple layers to generate an output in a Transformer architecture often entails hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the AI agent module 430 and its submodules 431-434 may be implemented by hardware, software and/or a combination thereof. For example, the AI agent module 430 and its submodules 431-434 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the AI agent module 430 and its submodules 431-434 and/or any other neural network models hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the AI agent module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI agent module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the AI agent module 430 and its submodules 431-434 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI agent module 430 may generate, by at least one ASIC (such as a TPU, etc.) performing a multiplicative and/or accumulative operation for a neural network language model, a next token based at least in part on previously generated tokens, and in turn generate a natural language output representing the next-step action combining a sequence of generated tokens.

In one embodiment, the neural network based AI agent module 430 and one or more of its submodules 431-434 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as data samples from datasets of fiction, papers, arxiv, wikipedia, codebases are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding give an example of ground truth label) from the training data, to compute a loss function that measures the discrepancy between the predicted output and the expected output. For example, the loss function may be cross entropy, minimum mean square error (MMSE), and/or the like. Given the loss, the negative gradient of the loss function is computed with respect to each weight of each layer individually. Such a negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network-based AI agent module 430 and one or more of its submodules 431-434 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

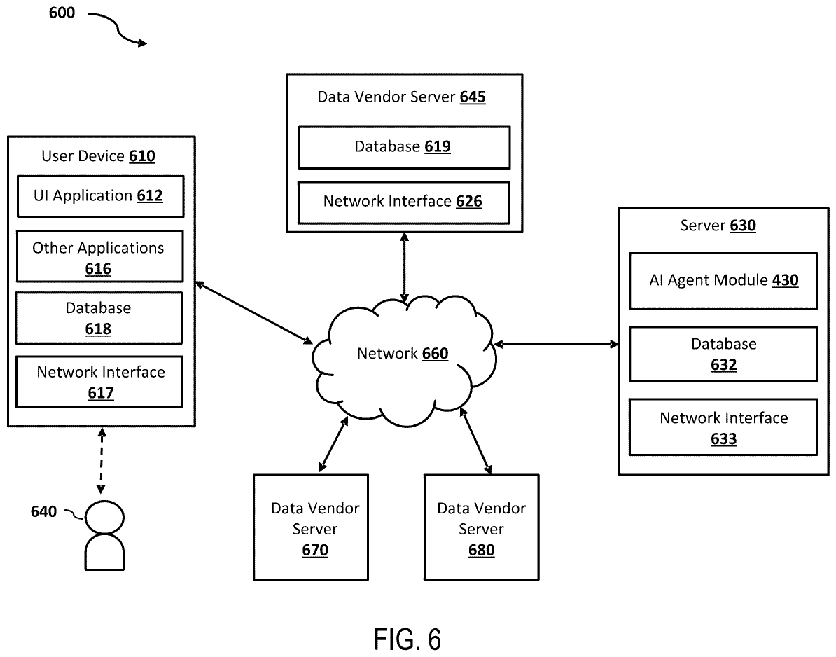

In one embodiment, AI agent module 430 and its submodules 431-434 may be housed at a centralized server (e.g., computing device 400) or one or more distributed servers. For example, one or more of AI agent module 430 and its submodules 431-434 may be housed at external server(s). The different modules may be communicatively coupled by building one or more connections through application programming interfaces (APIs) for each respective module. Additional network environments for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as identifying an IT anomaly, generating a code snippet to solve a problem, and/or the like.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI assistance in solving problems such as code generation and debugging, IT support, and/or the like.

FIG. 6 is a simplified block diagram of a networked system suitable for implementing the AI bot described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a visualized response (e.g., 105 in FIG. 1) from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI agent module 430 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI agent module 430 may generate a response via the process described in FIGS. 1-5. The AI agent module 430 may thus cause a display of the response at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view the response.

User device 610 may further include database 618 stored in a transitory and/or non-transitory memory of user device 610, which may store various applications and data and be utilized during execution of various modules of user device 610. Database 618 may store a user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets to the server 630. The database 619 may be implemented by one or more relational databases, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI agent module 430 and its submodules described in FIG. 4. In some implementations, AI agent module 430 may receive data from database 619 at the data vendor server 645 via the network 660 to generate a response. The generated response may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the AI agent module 430. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

In some embodiments, methods described herein are applicable in a variety of applications. For example, the task request (e.g., user query in FIG. 1) received by a neural network model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing methods, the neural network based artificial agent may improve technology in the respective technical field in healthcare and diagnostics, education and personalized learning, software development and code assistance, content creation, autonomous systems (such as autonomous driving, etc.), and/or the like.

For example, when the task request includes a query to identify an information technology (IT) anomaly relating to a usage of an IT component such as a network gateway, a router, an online printer, and/or the like, by performing methods 700-800 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Work Flows

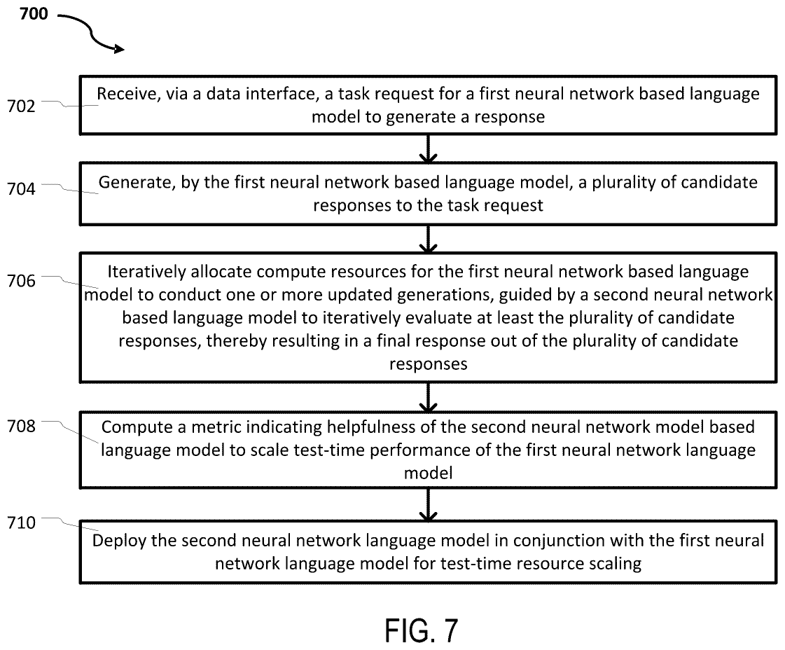

FIG. 7 is an example logic flow diagram illustrating a method of test-time resource scaling for neural network based language models based on the framework shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI agent module 430 (e.g., FIGS. 4 and 6) that performs test-time scaling.

In some embodiments, method 700 is performed by a system such as computing device r00, user device 610, server 630, or another device or combination of devices. Inputs (e.g., input query 106) may be received via a data interface such as data interface 415, network interface 617, network interface 633, or via a data interface that is integrated with a device. For example UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, a task request (e.g., input query 106 in FIG. 1) may be received, via a data interface, for a first neural network based language model (e.g., LLM 110 in FIG. 1) to generate a response.

At step 704, the first neural network based language model (e.g., LLM generators 110a-n in FIG. 2) may generate a plurality of candidate responses (e.g., 118a-d in FIGS. 3A-3C) to the task request.

At step 706, compute resources may be iteratively allocated for the first neural network based language model to conduct one or more updated generations, guided by a second neural network based language model (e.g., LLM judges 120a-m in FIG. 2) to iteratively evaluate at least the plurality of candidate responses, thereby resulting in a final response (e.g., 108b, 157, 128b in FIGS. 3A-3C) out of the plurality of candidate responses. For example, in one implementation, the second neural network based language model may generate a ranking of the plurality of candidate responses, and select the final response from the ranking of the plurality of candidate responses, as shown in FIG. 3A. For another example, the plurality of candidate responses are partial responses (e.g., the first few lines of a generated code segment, etc.) to the task request, and the second neural network based language model may select multiple candidate responses (e.g., 141, 143 in FIG. 3B) from the plurality of candidate responses. A beam search may be conducted by resampling an output distribution of the first neural network based language model to generate a new line continuing from the multiple candidate responses to form updated candidate responses (e.g., 151, 153, etc. in FIG. 3B), respectively. The first neural network based language model may iteratively generate updated candidate responses until a last full response (e.g., 157 in FIG. 3B) is generated and selected. For example, the second neural network based language model may generate corresponding critiques for each of the plurality of candidate responses and then the first neural network based language model may refine a plurality of revised candidate responses based on the corresponding critiques. The second neural network based language model may select the final response (e.g., 128b in FIG. 3C) by ranking the plurality of candidate responses and the plurality of revised candidate responses together.

At step 708, a metric indicating helpfulness of the second neural network model based language model to scale test-time performance of the first neural network language model may be computed. For example, the metric is computed based on an average performance of a greedily decoded response by the first neural network based language model, and an average performance of the final response selected by the second neural network based language model, e.g., Eq. (1). Depending on the type of task request, the average performance is quantified by one or more of: numerical equality of parsed final answer; equivalence of parsed final answer; grading on final answer using another neural network based language model; whether a generated code passes a test; prompt-level accuracy, and/or the like, as shown in Table 1.

At step 710, the second neural network language model may be deployed in conjunction with the first neural network language model for test-time resource scaling. For example, the second neural network language model (e.g., 120a in FIG. 2) may be deployed in conjunction with the first neural network language model (e.g., 110a in FIG. 2) for test-time resource scaling in response to the metric being greater than a pre-defined threshold. Otherwise, a third neural network based language model (e.g., 120b in FIG. 2) may be evaluated in a similar way of method 700 for test-time resource scaling with the first neural network based language model (e.g., 110a in FIG. 2), in response to the metric being less than the threshold.

In some embodiments, method 700 is applicable in a variety of applications. For example, the task request received by a neural network model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method Z700, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 700 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Data Experiments

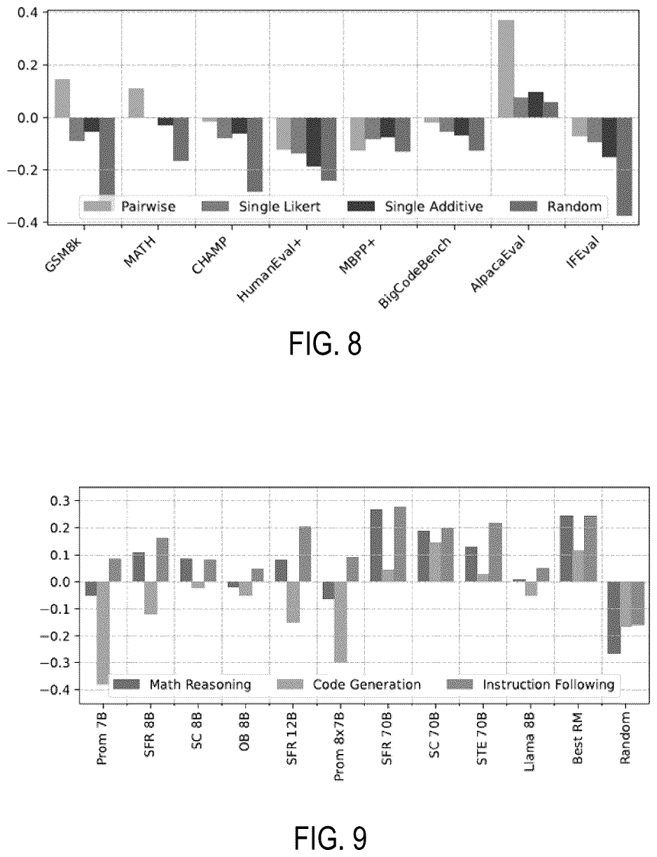

FIGS. 8-19 provide example results of data experiments of LLM judge evaluation framework for test-time scaling described in FIGS. 1-7. In one embodiment, the LLM judge evaluation benchmark may comprise eight datasets spanning three task categories: math reasoning, code generation, and instruction following. In all tasks, Llama 3.1 (Dubey et al., The llama 3 herd of models. arXiv preprint arXiv: 2407.21783, 2024) and Qwen 2.5 (Yang et al., Qwen2. 5 technical report. arXiv preprint arXiv: 2412.15115, 2024) are utilized. For math and code tasks, four domain-specific models are also considered, including newer models—Qwen Math and Qwen Coder—as well as older models—DeepSeek Math (Shao et al., Deepseekmath: Push-ing the limits of mathematical reasoning in open language models. arXiv preprint arXiv: 2402.03300, 2024) and DeepSeek Coder (Guo et al., Deepseek-coder: When the large language model meets programming—the rise of code intelligence. arXiv preprint arXiv: 2401.14196, 2024). Table 1 shows the datasets and associated evaluation metrics, e.g., used in Eq. (1) for the corresponding task.

TABLE 1
Datasets and Evaluation Metrics

| Task | Dataset | Size | Evaluation metric |
|---|---|---|---|
| Math | GSM8k | 1319 | Numerical equality of parsed final |
| Reasoning | | | answer |
| | MATH | 1324 | SymPy equivalence of parsed final |
| | (Lvl 5) | | answer |
| | CHAMP | 270 | GPT-4o grading on final answer |
| | | | summary |
| Code | HumanEval+ | 164 | Pass @ 1 |
| Generation | MBPP+ | 378 | Pass @ 1 |
| | BigCodeBench | 1140 | Pass @ 1 |
| Instruction | AlpacaEval | 805 | Win rate vs. GPT-4, judged by |
| Following | | | GPT-4 |
| | IFEval | 541 | Prompt-level strict accuracy |

This selection is made to analyze how judge-based test-time scaling influences models of varying strengths. The example LLM generators (e.g., 110a-nn in FIG. 2) and LLM judge (e.g., 120a-m in FIG. 2) are listed in Table 2.

As shown in Table 2, the following LLM-judge models were benchmarked: the vanilla Llama-3.1-8B-Instruct model with SFRJudge prompts for response reranking; three ORMs for response reranking: Llama-3-OffsetBias-RM-8B (OBRM), Skywork-Reward-Llama-3.1-8B-v0.2, Skywork-Reward-Gemma-2-27B-v0.2 (SRM) and PRM Qwen2.5-Math-PRM-7B (QPRM) for beam search.

TABLE 2
Example LLM Generator and Judge

| Generator Model | # Params | | Generator Model | #Params | |
|---|---|---|---|---|---|
| Llama-3.1-Instruct | 8, 70 | B | Qwen-2.5-Instruct | 32, 72 | B |
| Deepseek-Math-Instruct | 7 | B | Qwen-2.5-Math | 7 | B |
| Deepseek-Coder-Instruct | 6, 7 | B | Qwen-2.5-Coder | 7 | B |

| | | | | | Supported Capability | | |
|---|---|---|---|---|---|---|---|
| Judge Model | | Abbr. | # Params | | Pairwise | Single | Critique |
| SFRJudge | (Wang et al., 2024a) | SFR | 8, 12, 70 | B | ✓ | ✓ | ✓ |
| Skywork-Critic | (Shiwen et al., 2024) | SC | 8, 70 | B | ✓ | X | X |
| OffsetBias | (Park et al., 2024) | OB | 8 | B | ✓ | X | X |
| Prometheus | (Kim et al., 2024) | Prom | 7, 8 × 7 | B | ✓ | ✓ | ✓ |
| Self-Taught-Eval. | (Wang et al., 2024b) | STE | 70 | B | ✓ | X | X |
| Themis | (Hu et al., 2024) | Thm | 8 | B | X | ✓ | ✓ |

In one embodiment, the evaluation benchmark does not include any judges that support direct reranking of N responses. Instead, the evaluation used either pairwise round-robin comparison, where judges compare pairs of responses and provide a preference score, or single-instance rating, where judges rate individual responses. Two types of single-instance rating prompts were experimented with: Likert scale, where judges are asked to rate responses on a 1-5 scale without being given detailed criteria, and additive criteria, which instructs the model to incrementally increase the score based on given criteria, with a maximum score of 5.

The normalized helpfulness per dataset, averaged across judges and generators, along with the respective random performance, is plotted in FIG. 8. Two notable trends emerge from the results. First, the pairwise protocol typically performs better than the single-rating protocol with either Likert or additive rubric, with the exception of MBPP+, where all protocols perform worse than the greedy baseline. This finding is consistent with past research, where both humans and LLM-judges are better at providing pairwise comparison responses than single-rating responses. Given this, the pairwise protocol is used for reranking in the next two benchmarking tasks, step-level beam search and critique-based refinement, whenever possible. However, this comes at a significant inference cost, as the judge inference for pairwise reranking takes O(N\hat{ }2) time for N responses to rerank, compared to O(N) for single-instance rating. Second, there are significant variations across datasets, even within the same task category: the pairwise protocols help on GSM8k and MATH but not CHAMP, and all protocols help on AlpacaEval but none on IFEval. Overall, the judge helpfulness highly depends on the dataset, and further fine-grained analyses to understand the strengths and weaknesses of judgment would be valuable.

The normalized helpfulness of each judge on each task category for the pairwise protocol, aggregated over respective datasets and all generator models, is plotted in FIG. 9. With few exceptions, all judges, including the vanilla Llama-3.1-8B Instruct with judge prompt and the reward models, demonstrate the highest helpfulness for instruction following, less but mostly positive helpfulness for math reasoning, and mostly negative helpfulness for code generation. For single-rating protocols, consistent with FIG. 8, the helpfulness is much lower, but the relative ranking is still generally the same.

The consistency of inter-task helpfulness among judges coincides with the instruction-following training (and prompting) emphasis of current LLM-judges. Despite training data including both math and code samples, judge-specific finetuning seems to primarily boost instruction-following evaluation abilities, sometimes at the cost of other capabilities. This effect is shown in FIG. 9, where the vanilla Llama 3.1 8B model, prompted as a judge, exhibits a baseline level of competency as a judge, performing roughly at the greedy response level. Comparably sized 7B/8B judge models outperform it significantly on instruction-following tasks and moderately on math tasks, but performance degrades, sometimes significantly, on coding tasks.

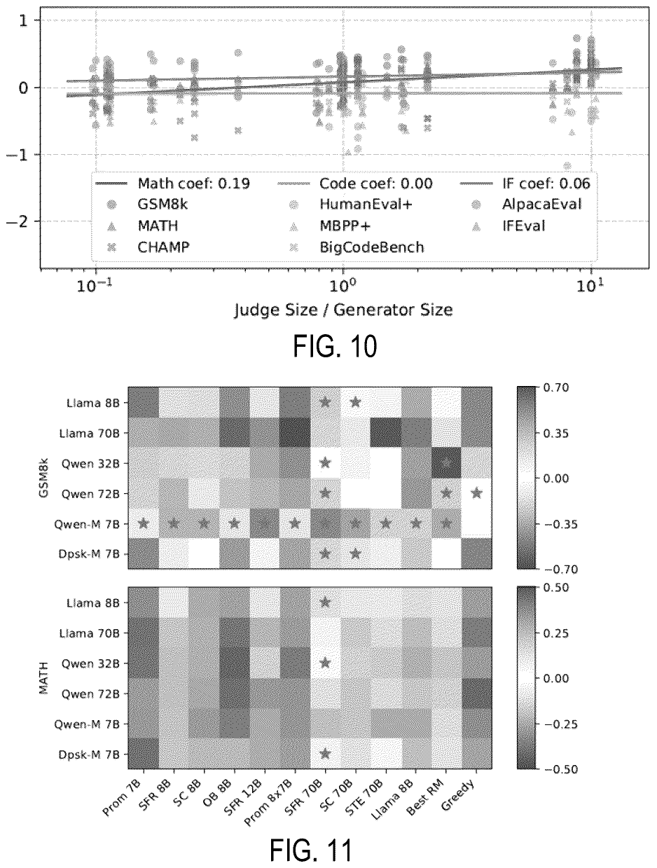

For each pair of judge and generator, FIG. 10 plots the ratio of the number of parameters in the judge to that in the generator (on log-scale) vs. the helpfulness achieved by the judge, color-coded by task category. A linear regression is plotted for each task on the log-scale size ratio. For math reasoning, a larger size ratio significantly increases helpfulness, indicating the promise of larger judges for small generator models, which, nonetheless, may not be practical at test-time. At the lower end of size ratio around 0.1 (e.g., 8B judge for 70B generator), normalized helpfulness is negative on average, indicating the absence of “weak-to-strong” guidance ability for LLM-judges. For instruction following, all size ratios achieve positive helpfulness but the effect of ratio increase is less notable. For code generation, the size ratio does not have an effect on the helpfulness, which is negative at all size ratios.

For single-ratings protocol with Likert and additive rubrics, the effect of the size ratio on helpfulness is positive only on math datasets, at 0.08 and 0.06 for the two rubric types, while that for instruction following is −0.01 and even worse for code, at −0.05 and −0.06.

No judge can reliably outperform majority-vote on math datasets. The output format specification of GSM8k and MATH allows us to easily extract the final answer from the generated response, and compute the majority-vote (i.e., self-consistency) performance. In FIG. 11, we plot the difference in the normalized helpfulness between each judge and this heuristic and mark all positive cells with purple stars. Except for Qwen-Math on GSM8k, only SFR 70B and SC 70B (along with the best RM) are able to beat majority-vote for some generators on GSM8k, and only SFR 70B on MATH. Thus, in theory, an LLM that simply extracts the majority-vote answer could serve as a very strong reranker for these datasets.

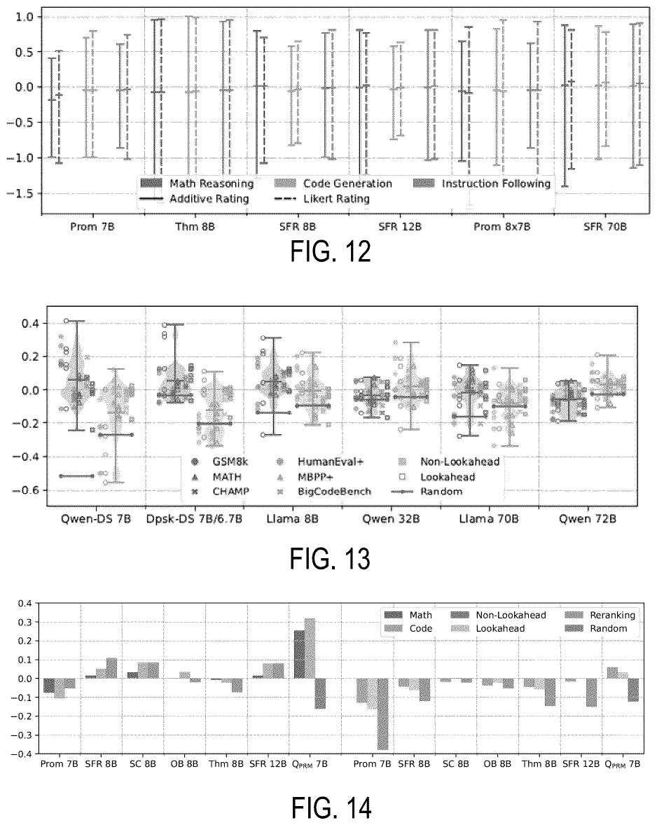

Judges are over-lenient under the single rating protocol, resulting in a large number of top-ranked responses. Despite being more time-efficient, the single-rating evaluation protocol performance results in evaluation that is too lenient. Multiple responses tied as the “best” response leads to large ranges of possible reranking performance. FIG. 12 shows the average performance, as well as the minimum and maximum achievable performances from the tied responses. If one were to employ random tie-breaking, performance can swing from extremely poor to near oracle.

FIG. 13 shows the distribution of judge performance for different generators. For math reasoning, positive mean helpfulness occur exclusively on small generators, Qwen-M 7B, Dpsk-M 7B and Llama 8B models, while not able to outperform the greedy response for any larger 32B-72B models. For code, beam search hurts significantly for both domain-specific models, and is not meaningfully beneficial for other models either.

FIG. 14 compares the normalized helpfulness of non-lookahead vs. lookahead beam search for different judges, along with reranking, random and QPRM performance. For math reasoning, while some judges can achieve positive helpfulness and even exceed reranking methods (though with much more judge inference), by far the best result is achieved by QPRM, notably with only 7B parameters. For code generation, no judges achieve significantly positive helpfulness, while QPRM, even though finetuned on math data, still achieves decent helpfulness. These results suggest that even though judges are finetuned to work with flexible rubrics, the process judgment is probably still out-of-distribution enough for the them to be ineffective.

In the lookahead mode, judges evaluate full, rolled out responses rather than incomplete ones, closer to their training data. However, somewhat surprisingly, lookahead is not universally beneficial. For math reasoning, FIG. 14 shows that it benefits four judges and QPRM, sometimes by two to three times, while slightly hurting the other two. For code generation, it benefits three judges and QPRM while hurting the other three, with much milder effects. For SC 8B and OB 8B, the only two judges that do not engage in chain-of-thought style reasoning, lookahead helps in all cases, though very mildly except on SC 8B for math reasoning. Overall, judges that perform well on reranking full responses tend to benefit from lookahead, whereas weaker ones tend to benefit from non-lookahead. This suggests that splitting full responses into shorter chunks makes evaluation easier for them, despite the out-of-distribution nature of step-level evaluation.

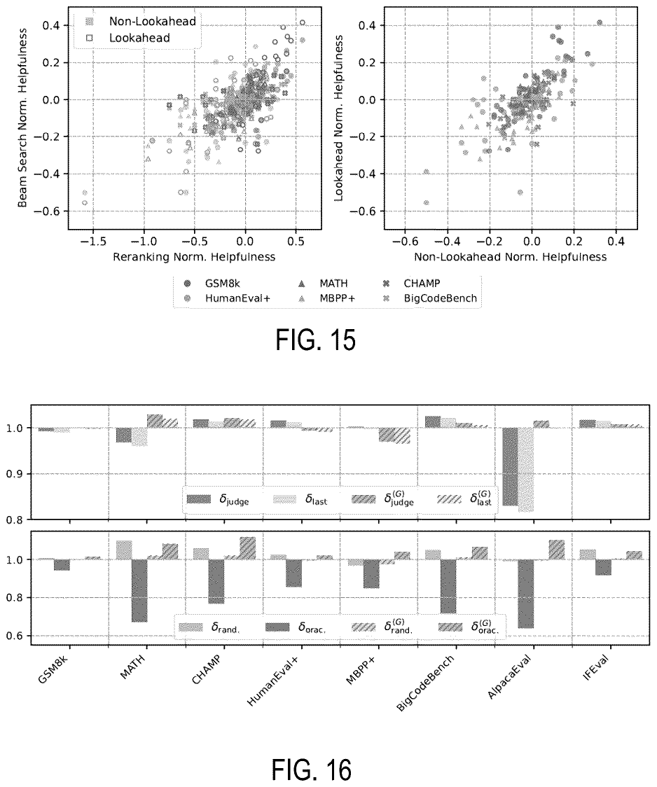

FIG. 15 plots the correlation between each judge's reranking performance and beam search performance (left), and the correlation between its lookahead and non-lookahead performance (right), with each scatter point representing a pair of dataset and generator. High correlation is observed among the three quantities, suggesting that they are all likely to be tied under the same underlying “fundamental judging capability” of the judge.

In FIG. 16 (top), the LLM judge and last performance ratios are plotted for each dataset, averaging across judges and generators. For the refinement to be practically useful, it should outperform both reranking and the original greedy response. However, except for CHAMP, on no datasets are both δ_{judge} and δ^{(G)}_{judge} meaningful.

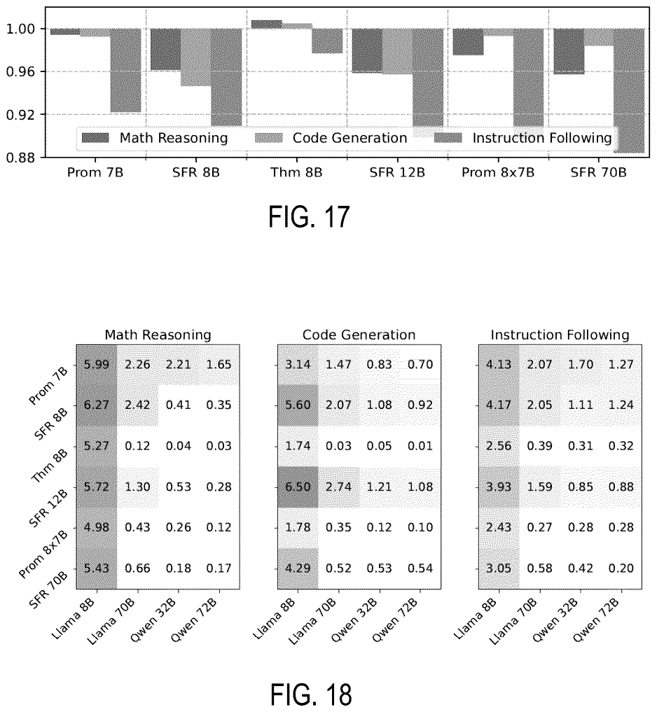

The final selected response is often generated early on. For individual judges, FIG. 17 plots the average effective improvement ratio for each judge, which is the minimum of δ_{judge} and δ^{(G)}_{judge} for each (dataset, generator) pair. Except for Themis, which achieves a meager less 1% relative improvement on math and code, no judge is beneficial beyond both reranking and greedy baseline.

The benefit of final reranking is small. While FIG. 16 (top) shows that δjudge is consistently better than δlast, the difference is small. Considering that the pairwise reranking takes O(N\hat{ }2) time, skipping it and simply taking the last refinement may be practically favorable.

Generators and judges rarely engage in extensive refinement processes. A notable trend from FIG. 16 (bottom) is that Llama 8B revised for significantly more rounds than other generators. This may suggest an intrinsic pliability to taking feedback, and/or result from its initial greedy response being much worse. In addition, Prometheus 7B is much better at giving actionable advice to encourage refinement behavior, which unfortunately does not translate to meaningful benefits in the final result (FIG. 17).

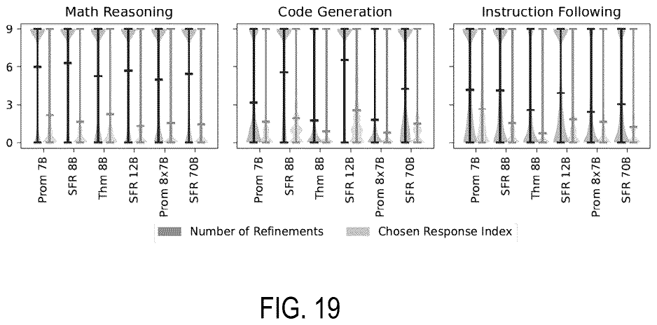

In FIG. 18, the total number of generated refinements (excluding the original greedy response) is plotted across the three task categories. Among the four generator models, Llama 8B revised for significantly more rounds than other generators. This may suggest an intrinsic pliability to taking feedback, and/or result from its initial greedy response being much worse. In addition, Prometheus 7B is much better at giving actionable advice to encourage refinement behavior, which unfortunately does not translate to meaningful benefits in the final result (FIG. 17).

For Llama 8B, FIG. 19 plots the distribution of number of refinements (excluding the greedy seed response) and distribution of the chosen response index (0 for greedy). The model tends to either refine very minimally, or use up all nine rounds. However, the response actually chosen by the final reranking tends to be generated much earlier in the process, with the seed response (index 0) still most likely to be chosen, revealing limited utility of the critiques.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of test-time resource scaling for neural network based language models, the method comprising:
receiving, via a data interface, a task request for a first neural network based language model to generate a response;
generating, by the first neural network based language model, a plurality of candidate responses to the task request;
iteratively allocating compute resources for the first neural network based language model to conduct one or more updated generations, guided by a second neural network based language model to iteratively evaluate at least the plurality of candidate responses, thereby resulting in a final response out of the plurality of candidate responses;
computing a metric indicating helpfulness of the second neural network model based language model to scale test-time performance of the first neural network language model; and
deploying the second neural network language model in conjunction with the first neural network language model for test-time resource scaling.

2. The method of claim 1, wherein the iteratively allocating compute resources for the first neural network based language model to conduct one or more updated generations comprises:
generating, by the second neural network based language model, a ranking of the plurality of candidate responses; and
selecting the final response from the ranking of the plurality of candidate responses.

3. The method of claim 1, wherein the plurality of candidate responses are partial responses to the task request, and the iteratively allocating compute resources for the first neural network based language model to conduct one or more updated generations comprises:
selecting, by the second neural network based language model, multiple candidate responses from the plurality of candidate responses;
conducting a beam search by resampling an output distribution of the first neural network based language model to generate a new line continuing from the multiple candidate responses to form updated candidate responses, respectively; and
iteratively generating updated candidate responses until a last full responses is generated and selected.

4. The method of claim 1, wherein the iteratively allocating compute resources for the first neural network based language model to conduct one or more updated generations comprises:
generating, by the second neural network based language model, corresponding critiques for each of the plurality of candidate responses;
refining, by the first neural network based language model, a plurality of revised candidate responses based on the corresponding critiques; and
selecting, by the second neural network based language model, the final response by ranking the plurality of candidate responses and the plurality of revised candidate responses together.

5. The method of claim 1, wherein the metric is computed based on an average performance of a greedily decoded response by the first neural network based language model, and an average performance of the final response selected by the second neural network based language model.

6. The method of claim 5, wherein the average performance is quantified by one or more of:
numerical equality of parsed final answer;
equivalence of parsed final answer;
grading on final answer using another neural network based language model;
whether a generated code passes a test;
prompt-level accuracy.

7. The method of claim 1, wherein the task request comprises one or more of math reasoning, code generation and instruction following.

8. The method of claim 1, wherein the deploying the second neural network language model in conjunction with the first neural network language model for test-time resource scaling is in response to the metric being greater than a threshold.

9. The method of claim 8, further comprising:
evaluating a third neural network based language model for test-time resource scaling with the first neural network based language model, in response to the metric being less than the threshold.

10. A system for test-time resource scaling for neural network based language models, the system comprising:
a memory that stores a plurality of processor executable instructions;
a communication interface that receives a task request for a first neural network based language model to generate a response; and
one or more hardware processors that read and execute the plurality of processor-executable instructions from the memory, wherein the plurality of processor-executable instructions are configurable to cause the system to perform operations comprising:
generating, by the first neural network based language model, a plurality of candidate responses to the task request;
iteratively allocating compute resources for the first neural network based language model to conduct one or more updated generations, guided by a second neural network based language model to iteratively evaluate at least the plurality of candidate responses, thereby resulting in a final response out of the plurality of candidate responses;
computing a metric indicating helpfulness of the second neural network model based language model to scale test-time performance of the first neural network language model; and
deploying the second neural network language model in conjunction with the first neural network language model for test-time resource scaling.

11. The system of claim 10, wherein the operation of iteratively allocating compute resources for the first neural network based language model to conduct one or more updated generations comprises:
generating, by the second neural network based language model, a ranking of the plurality of candidate responses; and
selecting the final response from the ranking of the plurality of candidate responses.

12. The system of claim 10, wherein the plurality of candidate responses are partial responses to the task request, and the operation of iteratively allocating compute resources for the first neural network based language model to conduct one or more updated generations comprises:
selecting, by the second neural network based language model, multiple candidate responses from the plurality of candidate responses;
conducting a beam search by resampling an output distribution of the first neural network based language model to generate a new line continuing from the multiple candidate responses to form updated candidate responses, respectively; and
iteratively generating updated candidate responses until a last full responses is generated and selected.

13. The system of claim 10, wherein the operation of iteratively allocating compute resources for the first neural network based language model to conduct one or more updated generations comprises:
generating, by the second neural network based language model, corresponding critiques for each of the plurality of candidate responses;
refining, by the first neural network based language model, a plurality of revised candidate responses based on the corresponding critiques; and
selecting, by the second neural network based language model, the final response by ranking the plurality of candidate responses and the plurality of revised candidate responses together.

14. The system of claim 10, wherein the metric is computed based on an average performance of a greedily decoded response by the first neural network based language model, and an average performance of the final response selected by the second neural network based language model.

15. The system of claim 14, wherein the average performance is quantified by one or more of:
numerical equality of parsed final answer;
equivalence of parsed final answer;
grading on final answer using another neural network based language model;
whether a generated code passes a test;
prompt-level accuracy.

16. The system of claim 10, wherein the task request comprises one or more of math reasoning, code generation and instruction following.

17. The system of claim 10, wherein the operation of deploying the second neural network language model in conjunction with the first neural network language model for test-time resource scaling is in response to the metric being greater than a threshold.

18. The system of claim 17, wherein the operations further comprise:
evaluating a third neural network based language model for test-time resource scaling with the first neural network based language model, in response to the metric being less than the threshold.

19. A non-transitory machine-readable medium comprising a plurality of instructions for test-time resource scaling for neural network based language models, executable by one or more processors, wherein the plurality of instructions are configurable to cause the one or more processors to perform operations comprising:
receiving, via a data interface, a task request for a first neural network based language model to generate a response;
generating, by the first neural network based language model, a plurality of candidate responses to the task request;
iteratively allocating compute resources for the first neural network based language model to conduct one or more updated generations, guided by a second neural network based language model to iteratively evaluate at least the plurality of candidate responses, thereby resulting in a final response out of the plurality of candidate responses;
computing a metric indicating helpfulness of the second neural network model based language model to scale test-time performance of the first neural network language model; and
deploying the second neural network language model in conjunction with the first neural network language model for test-time resource scaling.

20. The medium of claim 19, wherein the operation of plurality of candidate responses are partial responses to the task request, and the iteratively allocating compute resources for the first neural network based language model to conduct one or more updated generations comprises:
selecting, by the second neural network based language model, multiple candidate responses from the plurality of candidate responses;
conducting a beam search by resampling an output distribution of the first neural network based language model to generate a new line continuing from the multiple candidate responses to form updated candidate responses, respectively; and
iteratively generating updated candidate responses until a last full responses is generated and selected.
